(19) United States
(12) Patent Application Publication
(10) Pub. No.: US 2010/0165620 A1
(43) Pub. Date: Jul. 1, 2010

(54) REFLECTOR CHANNEL

(75) Inventor: JONATHAN L. MARSON, HILLSBORO, OR (US)

Correspondence Address: MARGER JOHNSON & MCCOLLOM, P.C., 210 SW MORRISON STREET, SUITE 400, PORTLAND, OR, 97204, US

(73) Assignee: PHOSEON TECHNOLOGY, INC., HILLSBORO, OR (US)

(21) Appl. No.: 12/345,499

(22) Filed: Dec. 29, 2008

(51) Int. Cl. F21V 7/00

(52) U.S. Cl. 362/235

(57) ABSTRACT

A lighting module has an array of solid-state light sources on a substrate, a reflector channel arranged adjacent to the array of solid-state light sources, the reflector channel having curved, reflective inner surfaces arranged to increase collimation of light emitted from the light sources in one axis of light. A method of manufacturing a lighting module includes providing a substrate, mounting an array of solid-state light sources on the substrate, manufacturing a reflector channel, wherein the size and arrangement of the reflector channel depends upon the array of light sources, and arranging the reflector channel on the substrate such that light emitting from the light sources will be reflected in a desired direction

### BACKGROUND

Using solid-state light sources, such as light emitting diodes (LEDs) and laser diodes, has several advantages over traditional lamps. Solid-state light sources generally use less power, generate less heat and have higher reliability. Some modifications may increase their effectiveness and efficiency even more.

For example, LEDs generally emit light in a hemispherical pattern that may benefit from some directional control. One solution involves directing the light from the LEDs towards a reflective surface, which in turn redirects the light without increasing collimation. U.S. Pat. No. 6,149,283 to Conway, et. al., issued Nov. 11, 2000, discloses an example of this approach.

In another approach, disclosed in U.S. Pat. No. 5,130,761, to Tanaka, issued Jul. 14, 1992, a flat reflective surface receives the light from an LED mounted on the substrate. The reflective surface then directs some of the light in a direction generally parallel to the substrate.

U.S. Pat. No. 6,683,421, issued Jan. 27, 2004, to Kennedy, et. al., wedge-shaped, straight-walled reflective pieces are inserted between the LEDs on a substrate to redirect sidewall light in a different direction. Sidewall light is light that the LED emits parallel with the substrate.

None of these approaches serve to increase the collimation of the light emitted from the LED. They generally address directing the light in whole in a particular direction, or, in the case of Kennedy, capturing a particular type of light leakage. They do not address increasing the collimation of the light from an LED into a particular direction to increase the overall efficiency and the peak radiance of a lighting fixture.

### BRIEF DESCRIPTION OF THE DRAWINGS

FIG. 1 shows a side view of an embodiment of a reflector channel for a solid-state light source.

FIG. 2 shows an embodiment of an array of solid-state light sources on a substrate.

FIG. 3 shows a ray diagram of solid-state light source emissions without a reflector channel.

FIG. 4 shows an embodiment of an array of solid-state light sources having a reflector channel.

FIG. 5 shows a ray diagram of solid-state light source emissions with a reflector channel.

FIG. 6 shows a side view of an alternative embodiment of a reflector channel for an array of solid-state light sources.

FIG. 7 shows a detailed side view of an alternative embodiment of a reflector channel for an array of solid-state light sources.

### DETAILED DESCRIPTION OF THE EMBODIMENTS

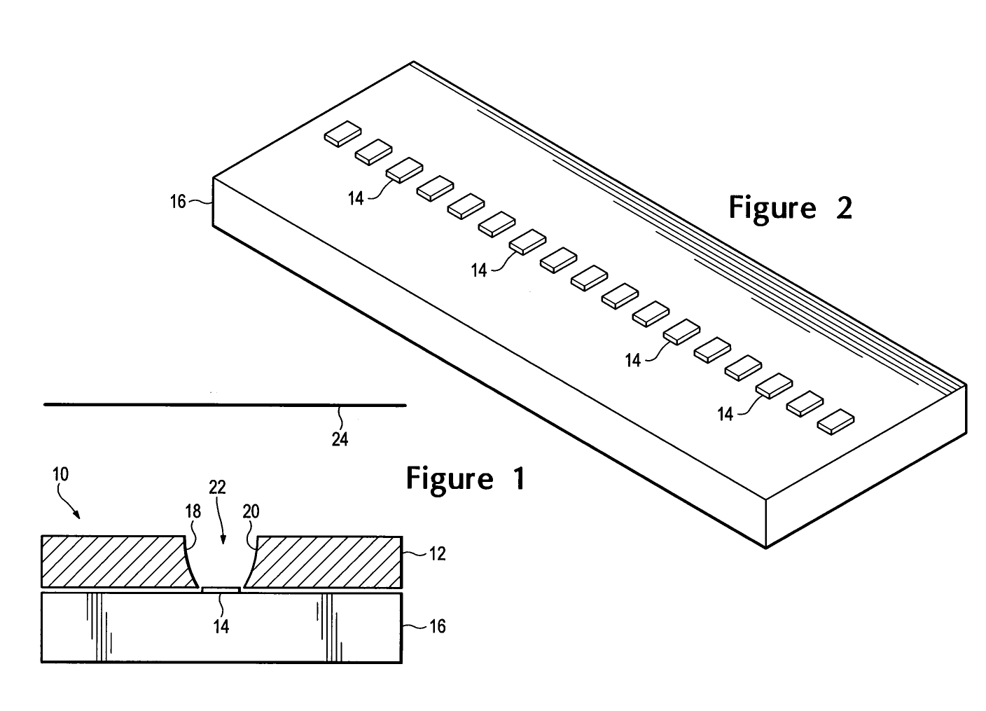

FIG. 1 shows a side view of a light module 10. The light module 10 has a reflector channel 12 for use with an array of solid-state light sources, which can only be seen as a single light source 14 in this view. The reflector channel may be viewed as an assembly of different pieces or components. The reflector channel 12 has inner surfaces, which may be manufactured out of different pieces of material, and a light channel 22.

The light source 14 resides on a substrate 16. The substrate may consist of silicon, glass, ceramic, diamond, SiC, AlN, BeO, Al₂O₃, or combinations of these or other materials, may be thermally conductive, and may be electrically insulative. These are just examples of possible materials, and are not intended in anyway to limit the scope of the invention as claimed.

The reflector channel 12 will generally consist of a piece or pieces of material that form curved, inner surfaces such as 18 and 20, arranged on either side of the light source 14. For some applications, only one of the inner surfaces may be used. The reflector channel 12 defines the light channel 22 through which light is directed towards a surface to be illuminated 24. Generally, the surfaces 18 and 20 will have a shape designed to collimate or concentrate the emitted light.

The reflector channel may be made from one piece of material with gaps in it to accommodate the light sources, or may be made from two pieces of material, each mounted on a side of the light sources. The material may consist of metal, polymers or plastics, including PVC (polyvinyl chloride). A metal that generally works well is aluminum, especially if the application involves curing using UV light, as aluminum has high reflectivity in the UV band. The reflector channel may be made of a soft metal from which the reflector shape can be stamped.

If the reflector channel is formed from a polymer or plastic, it may require some further processing to ensure high reflectivity. A reflective coating may be added to the reflector structure using thin film processes or other type of coating processes. One example coating includes Alzak™ by the Aluminum Company of America (ALCOA).

The reflector channel may be formed by cutting, stamping, injection molding or extrusion. Designs that use individual reflectors for each light source generate a high irradiance spot. When these spots are stacked end to end to create a line of light at a target surface, there is a trade off between uniformity and irradiance. The reflector channel could be extruded to a desired length with the curved inner surface or surfaces as needed which maintains uniform high irradiance light over the entire length at the target surface.

In one example, the light pattern desired at the surface 24 is a single or multi-line pattern. The lines of light need relatively high radiance in a relatively narrow space. The concentration or collimation of the light from the light source into the line pattern increases the irradiance at the surface. FIG. 2 shows an array of light sources such as 14 arranged in a line pattern.

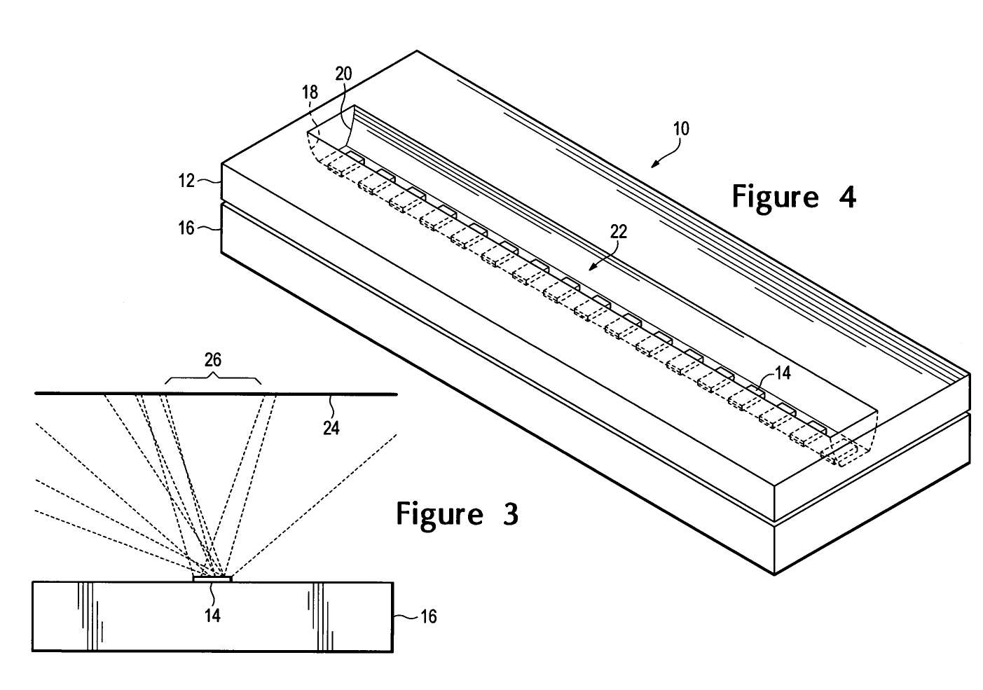

As shown in FIG. 3, the light source 14 emits light in a nearly-hemispherical pattern. The desired light pattern on surface 24 is essentially a line, shown by the region 26. Without some sort of optics or collimation, much of the light from the light source 14 will not reach the desired region. Further, the light that does reach the region will not have sufficient irradiance to effect the desired change.

One application, for example, of these types of lighting modules is curing of inks, adhesives and other coatings. Some of these curing applications use ultraviolet (UV) light, but all types of wavelengths should be considered. The coating resides on surface 24 and may have a necessary level of irradiance to effect the curing operation. By collimating the light into the line pattern, the lighting module can produce enough irradiance to cure the coating.

FIG. 4 shows the substrate 16 of FIG. 2 with the reflector channel 12 added. The reflector channel 12 may be mounted to the substrate using adhesives, brackets, screws, etc.

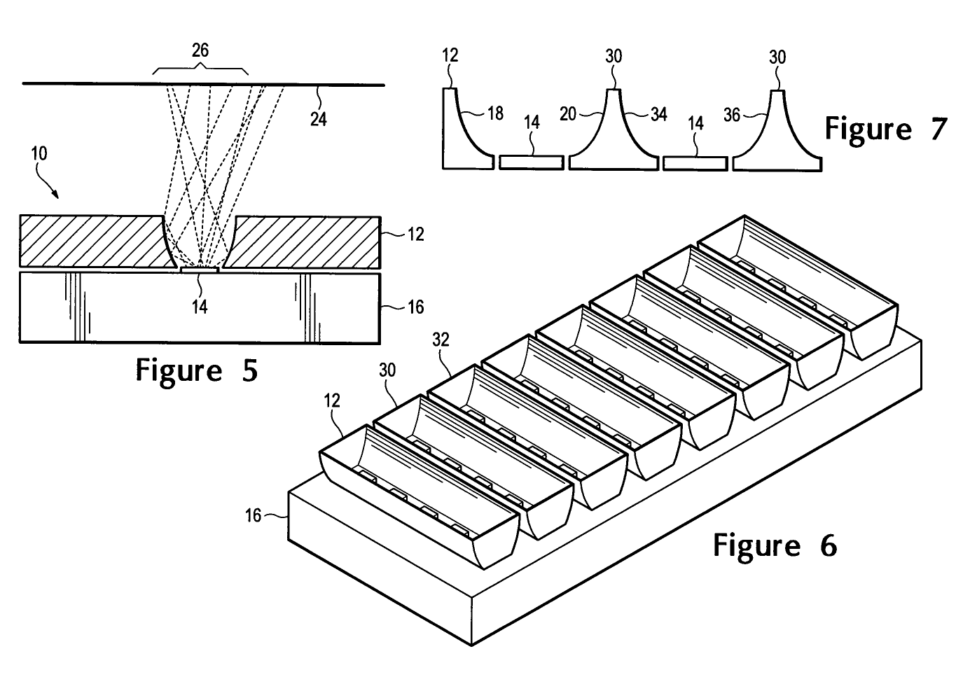

FIG. 5 is a ray diagram showing the resulting alteration of the light pattern. Referring back to FIG. 3, one can see that the light sources by themselves produced light in a near-hemispherical pattern. In FIG. 5, the same light source produces light in a near hemispherical pattern, but the resulting light pattern is much more collimated. The irradiance received in region 26 is significantly higher. Experiments show that the irradiance achieved using FIG. 5 is 204% of that achieved with FIG. 3.

While the discussion up to this point has focused on the production of a single line pattern, the reflector channel could also be used in arrangements where multiple line patterns could be produced. For example, the array of FIG. 2 is an array forming one column of single light sources. It is possible to have an array arranged on an x-y grid. It should be noted that the array of FIG. 2 is actually on an x-y grid, with one column on the x-axis. However, to differentiate that arrangement from one having more than 1 column, the term ‘x-y grid’ will be used for an array having two or more columns of light sources.

FIG. 5 shows an array of light sources such as 14 on the substrate 16. In this view, the array of light sources is arranged in an x-y grid, from left to right being defined as the x-axis, y-axis coming out of the page. Each column would have a reflector channel, such as 12, and 30, resulting in a light pattern having multiple bars of light exiting the light channels of the reflectors in the z-axis.

In the embodiment where a reflector channel resides between two adjacent columns of light sources, the profile of the reflector channel may differ from that shown in FIG. 1. As can be seen in FIG. 7, the reflector channel pieces such as 30 that reside between adjacent columns of light sources will have two curved surfaces, each a curved, inner surface but facing in opposite directions from each other. Reflector channel 12 has curved surfaces 18 and 20, as shown in FIGS. 1 and 7 where 18 and 20 are not necessarily the mirror image of the other. Reflector channel 30 has curved surfaces 34 and 36, with curved surface 34 and curved surface 20 residing on the same piece of material.

Alternatively, each reflector channel could reside separately, but this would increase the number of pieces of material necessary to provide reflector channels for the array of light sources, as well as increasing the spacing between the columns. To further increase the irradiance at the target, it is generally desirable to space the light sources closer together. Further, the size of the reflector is substantially equal to, or only slightly larger than, the size of the light source 14. This allows for the smallest possible column spacing.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A lighting module, comprising:
an array of solid-state light sources on a substrate; and
a reflector channel arranged adjacent to the array of solid-state light sources, the reflector channel having curved, reflective inner surfaces arranged to increase collimation of light emitted from the light sources in one axis of light.

2. The lighting module of claim 1, where the reflective surfaces are designed to concentrate the emitted light.

3. The lighting module of claim 1, further comprising an array of lenses arranged opposite the substrate and adjacent the reflector channel, the reflector channel arranged to direct light from the light sources to the array of lenses.

4. The lighting module of claim 3, wherein the array of lenses is arranged such that there is a corresponding lens to each light source.

5. The lighting module of claim 3, wherein the array of lenses is arranged such that there are more than one light source corresponding to each lens.

6. The lighting module of claim 1, wherein the reflector channel comprises one of a molded, stamped, or cut piece of material.

7. The lighting module of claim 6, wherein the material comprises metal, polymer, glass or plastic.

8. The lighting module of claim 7, wherein the material comprises a reflective coating.

9. The lighting module of claim 1, wherein the reflector channel is arranged such that the curved surfaces are on opposite sides of the light sources.

10. The lighting module of claim 1, wherein the array of solid-state light sources is arranged in a line and the reflector channel is arranged along the length of the line.

11. The lighting module of claim 1, wherein the array of solid-state light sources is arranged in an x-y grid, and the reflector channel comprises subchannels, each subchannel arranged along a line of the x-y grid.

12. The lighting module of claim 1, wherein the reflector channel has a size substantially equal to the size of the array of light sources.

13. A method of manufacturing a lighting module, comprising:
providing a substrate;
mounting an array of solid-state light sources on the substrate;
manufacturing a reflector channel, wherein the size and arrangement of the reflector channel depends upon the array of light sources; and
arranging the reflector channel on the substrate such that light emitting from the light sources will be reflected in a desired direction.

14. The method of claim 13, wherein mounting an array of solid-state light sources comprises mounting a line of solid-state light sources.

15. The method of claim 13, wherein arranging the reflector channel comprises arranging a reflector channel along the line of solid-state light sources.

16. The method of claim 14, wherein mounting an array of solid-state light sources comprises mounting the array in an x-y grid on the substrate.

17. The method of claim 16, wherein arranging the reflector channel comprises arranging reflector subchannels along parallel lines of the array of the solid-state light sources such that the subchannels have a common long axis.

18. The method of claim 13, wherein manufacturing a reflector channel comprises molding, stamping or cutting the reflector channel.

19. The method of claim 13, wherein manufacturing a reflector channel comprises manufacturing the reflector channel out of one of plastic or a polymer and then coating the channel with a reflective coating.

20. The method of claim 13, wherein manufacturing a reflector channel comprises one of manufacturing the reflector channel out of metal or extruding a material to a predetermined length, the predetermined length depending upon a length of the array of solid-state light sources.
